(19) United States
(12) Patent Application Publication
(10) Pub. No.: US 2005/0089104 A1
(43) Pub. Date: Apr. 28, 2005

(54) Video decoding method and apparatus for providing error detection

(75) Inventor: Sung-joo Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/974,714

(22) Filed: Oct. 28, 2004

(30) Foreign Application Priority Data
Oct. 28, 2003 (KR) 10-2003-0075646

(51) Int. Cl. H04N 7/12

(52) U.S. Cl. 375/240.27; 375/240.12

(57) ABSTRACT

Provided are a method and apparatus for detecting an error during video decoding and handling of the error. An error is detected in a received video stream having a predetermined format, error information is recorded at a predetermined location of the video stream, and the type of the error is determined using the recorded error information. The video decoder includes a broadcast signal receiver that extracts a broadcast stream from a broadcast signal being transmitted via a transmission medium, a demultiplexing and error detection unit that demultiplexes the broadcast stream of a predetermined format extracted by the broadcast signal receiver for extraction of a video stream, detects errors in packets making up the extracted video stream, and records error information at a predetermined location of the video stream, and a video decoding unit that interprets the error information, determines the type of the errors using a predetermined method, and decodes the video stream according to the result of determination. The type and position of an error may be determined during video decoding. The video decoder is able to improve video quality by performing proper error concealment according to the type of error determined.

### CROSS-REFERENCE TO RELATED APPLICATION

This application claims priority from Korean Patent Application No. 10-2003-0075646 filed on Oct. 28, 2003 in the Korean Intellectual Property Office, the disclosure of which is incorporated herein by reference in its entirety.

### BACKGROUND OF THE INVENTION

1. Field of the Invention

The present invention relates to a method and apparatus for detecting and handling errors during a video decoding process in a video decoder.

2. Description of the Related Art

With the development of information communication technology including the Internet, video communication as well as text and voice communication has increased. Conventional text communication cannot satisfy the various demands of users, and thus multimedia services that can provide various types of information such as text, pictures, and music have increased. Multimedia data requires a large capacity storage medium and a wide bandwidth for transmission since the amount of multimedia data is usually large. For example, a 24-bit true color image having a resolution of 640×480 needs a capacity of 640×480×24 bits, i.e., data of about 7.37 Mbits, per frame. When this image is transmitted at a speed of 30 frames per second, a bandwidth of 221 Mbits/sec is required. When a 90-minute movie based on such an image is stored, a storage space of about 1200 Gbits is required. Accordingly, a compression coding method is a requisite for transmitting multimedia data including text, video, and audio.

A basic principle of multimedia data compression is removing data redundancy. In other words, data can be compressed by removing spatial redundancy in which the same color or object is repeated in an image, temporal redundancy in which there is little change between adjacent frames in a moving image or the same sound is repeated in audio, or mental visual redundancy taking into account human eyesight and limited perception of high frequency. In existing video coding methods such as Motion Picture Experts Group (MPEG)-1, MPEG-2, H.263, and H.264, temporal redundancy is removed by motion compensation based on motion estimation and compensation, and spatial redundancy is removed by transform coding. The motion compensation removes temporal redundancy while transform coding removes spatial redundancy. The MPEG-2 standard (ISO/IEC 13818) is one of video and audio compression schemes and extends the MPEG-1 standards to provide encoding of high quality video that can be transmitted over a computer network. The MPEG-2 standard is basically designed to transmit video using an Asynchronous Transfer Mode (ATM). An ATM cell has 48 bytes of payload: one byte for an ATM Adaptation Layer (AAL) and the remaining 47 bytes for user information. An MPEG-2 packet consists of a 188-byte transport stream (TS) packet that is designed to be encapsulated within four ATM cells.

MPEG-2 is mainly intended to efficiently compress video for TV and HDTV transmission. Currently, TV and HDTV display MPEG-2 encoded video at bit rates of 3 to 9 Mbps and 17 to 30 Mbps, respectively. The MPEG-2 video standard basically removes spatial and temporal redundancies contained in a video and encodes the resulting video into a defined bitstream of a very short length for massive video data compression. Removing the spatial redundancy can be achieved by removing high frequency components that require a large amount of data but is not perceivable to the human eye using Discrete Cosine Transform (DCT) and quantization. Removing the temporal redundancy (similarity between video frames) is accomplished by detecting similarity between neighboring frames and transmitting motion vector information for redundant data instead of transmitting the redundant data, along with an error occurring when describing the motion by a motion vector. The error undergoes DCT and quantization.

Variable length coding (VLC) assigns shorter codes to frequently occurring bitstreams, thus achieving lossless compression of bitstreams. In particular, DCT coefficients are encoded into short bitstreams using a run length code. The compressed video data is properly transferred from a sending side to a receiving side along with audio data and parity information. That is, the sending side transmits MPEG-2 video data, audio, and parity information in an MPEG-2 compliant TS data format. After channel encoding, 188 byte TS packet data are converted and transmitted over a transmission channel along with error-checking codes such as cyclic redundancy check (CRC).

However, since digital TV broadcasting transmits a broadcast signal via a wireless medium, broadcast signal loss may occur during transmission. The broadcast signal loss results in loss in MPEG-2 TS packets, which causes poor video or audio quality. In particular, when the lost TS packet corresponds to a start code of a video elementary stream (ES), this adversely affects video quality. The MPEG-2 TS packets may be transmitted using an Internet Protocol (IP) instead of digital TV broadcasting. In this case, the TS packets are transmitted in real time using a User Datagram Protocol (UDP) instead of a Transmission Control Protocol (TCP) above an IP layer. When using UDP/EP for transport of the TS packets, a fraction of the TS packets may be lost because of the inherent non-connectivity and unreliability of the UDP. In particular, a packet loss may occur frequently over the wireless Internet. Dropping packets from a stream, in particular, the loss in a start code seriously degrades video or audio quality.

The current MPEG-2 video standard does not provide a special rule for checking whether there is an error in an incoming stream. A bit parser for analyzing a bitstream detects a start code that is a special bitstream beginning with 0×00 00 01, and a start code value is defined in the MPEG-2 video standard as shown in Table 1.

TABLE 1

| Name | Start code value (hexadecimal) |
|---|---|
| Picture_start_code | 00 |
| slice_start_code | 01 through AF |
| Reserved | B0 |
| Reserved | B1 |
| user_data_start_code | B2 |
| sequence_header_code | B3 |
| sequence_error_code | B4 |
| Extension_start_code | B5 |
| Reserved | B6 |
| sequence_end_code | B7 |
| group_start_code | B8 |
| System start codes (see note) | B9 through FF |

NOTE
System start codes are defined in Part 1 of this specification

For example, 0×00 00 01 00 represents a picture start code indicating the start of a header of a new picture. A video decoder prepares decoding of a new picture each time it detects the picture start code and initializes itself to be ready for decoding. The decoder skips bitstreams upon encountering an unknown or unnecessary start code until it finds the next start code that can be decoded.

An error may occur while transporting data in a wireless or digital TV broadcasting environment and adversely affect the video quality. Each MPEG-2 TS packet has a flag such as continuity counter or transport error indicator for detecting a packet loss or damage. Meanwhile, when data transmitted through UDP/IP suffer from damage, the damaged data is discarded and a continuity counter is used to determine if a packet loss has occurred. If there is an error or damage in a compressed ES, the video decoder cannot detect the error or damage and thus decodes the stream into a video format other than that intended by a sending side. In this way, an error is detected in compressed video streams and then preprocessed to make the displayed image less displeasing to human eyes. This technique for concealing the error is called error concealment.

For applying an error concealment technique, an error detection technique is needed. There are three error detection techniques: 1) error detection at a channel decoder; 2) syntactic error detection in an encoded bitstream at a video decoder independent from a channel decoder; and 3) semantic error detection that determines semantic discrepancy between a decoded block and an adjacent block. In the error detection at the channel decoder, the MPEG-2 channel decoder determines if an error has occurred during transmission and sets a transport error indicator flag in a TS packet in order to prevent transmission of a packet with an error to a video decoder. In this case, while a TS demultiplexer is aware of a loss or damage of the appropriate packet by reading a continuity counter error or a transport error indicator flag, the video decoder cannot exactly know information about the packet error. The syntactic and semantic error detection techniques cannot provide a satisfactory level of accuracy.

Thus, it is highly desirable for a video decoder to have a method for concealing errors according to information on damage or loss of an incoming packet that is made available to itself.

### SUMMARY OF THE INVENTION

The present invention provides a method and apparatus for detecting information about a packet error obtained after channel decoding for use in a video decoder.

According to an exemplary aspect of the present invention, there is provided a video decoding method with error detection which includes the steps of (a) detecting an error in a received video stream having a predetermined format and recording error information at a predetermined location of the video stream and (b) determining the type of the error using the error information recorded in the video stream and decoding the video stream according to the result of determination.

The format of the video stream is compliant with the Moving Pictures Experts Group (MPEG) standards. In step (a), information containing a start position and a length of the error is recorded in the video stream using information about lost or damaged Transport Stream (TS) packets detected during channel decoding for digital TV broadcasting, or packets lost during transmission over the Internet are detected using at least one of header information of a transport protocol and header information of packets being transmitted and information containing a start position and a length of the error in the video stream is recorded in the video stream. Here, the information containing the start position and length of the error in the video stream is preferably recorded in the form of a start code.

In step (b), the type of the error is classified into an error within a frame and an error between frames for determination, and video decoding is performed according to the type of the error determined. When the determined error is an error within a frame, decoding is performed on the frame with the error using blocks in a temporally preceding frame corresponding to a position in the frame where the error has occurred. When the determined error is an error between frames, video decoding is performed on a temporally preceding frame instead of a frame with a lost or damaged region placed at the beginning part of the frame.

According to another exemplary aspect of the present invention, there is provided a video decoder with error detection. The video decoder includes a broadcast signal receiver that extracts a broadcast stream from a broadcast signal being transmitted via a transmission medium, a demultiplexing and error detection unit that demultiplexes the broadcast stream of a predetermined format extracted by the broadcast signal receiver for extraction of a video stream, detects errors in packets making up the extracted video stream, and records error information at a predetermined location of the video stream, and a video decoding unit that interprets the error information, determines the type of the errors using a predetermined method, and decodes the video stream according to the result of determination.

The format of the video stream extracted by the broadcast signal receiver is preferably compliant with the Moving Pictures Experts Group (MPEG) standards. The broadcast signal receiver may display the information about a packet lost or damaged while extracting a broadcast stream from a broadcast signal transmitted for digital TV broadcasting, on the header of the packet, and the demultiplexing and error detection unit may demultiplex the broadcast stream for extraction of a video stream and may record error information containing a start position and a length of the error in the video stream using the information about the lost or damaged packet displayed on the header. Alternatively, the broadcast signal receiver may extract a broadcast stream (program) using the header information of packets transmitted over the Internet, and the demultiplexing and error detection unit may demultiplex the broadcast stream for extraction of a video stream and records error information containing a start position and a length of the error in the video stream using at least one of header information of a transport protocol and the header information of packets transmitted over the Internet. Meanwhile, the demultiplexing and error detection unit preferably records information containing the start position and length of the error in the video stream in the form of a start code.

Preferably, the decoding unit classifies a type of the error into an error within a frame and an error between frames for determination and performs video decoding according to the type of the error determined. When the determined error is an error within a frame, the video decoding unit preferably decodes the frame with the error using blocks in a temporally preceding frame corresponding to a position in the frame where the error has occurred. Also, when the determined error is an error between frames, the video decoding unit preferably decodes a temporally preceding frame instead of a frame with a lost or damaged region placed at the beginning part of the frame.

### BRIEF DESCRIPTION OF THE DRAWINGS

The above and other features and advantages of the present invention will become more apparent by describing in detail exemplary embodiments thereof with reference to the attached drawings in which:

FIG. 1 is a functional block diagram of a video decoder with error detection according to an exemplary embodiment of the present invention;

FIG. 2 is a flowchart illustrating a video decoding process with error detection according to an exemplary embodiment of the present invention;

FIG. 3 is a flowchart illustrating the detailed process that detects and handles overlapping of a macroblock/slice;

FIG. 4 illustrates the format of a MPEG-2 transport stream (TS) packet;

FIG. 5 illustrates an indication of information on an error detected in a stream so that a video decoder can be aware of the error;

FIG. 6A shows the structure of normal MPEG-2 video data;

FIG. 6B shows the structure of MPEG-2 video data in which information on error has been indicated;

FIGS. 7A-7D show examples of types of possible errors; and

FIG. 8 shows an example of a calculation process for determining the type of an error.

### DETAILED DESCRIPTION OF THE INVENTION

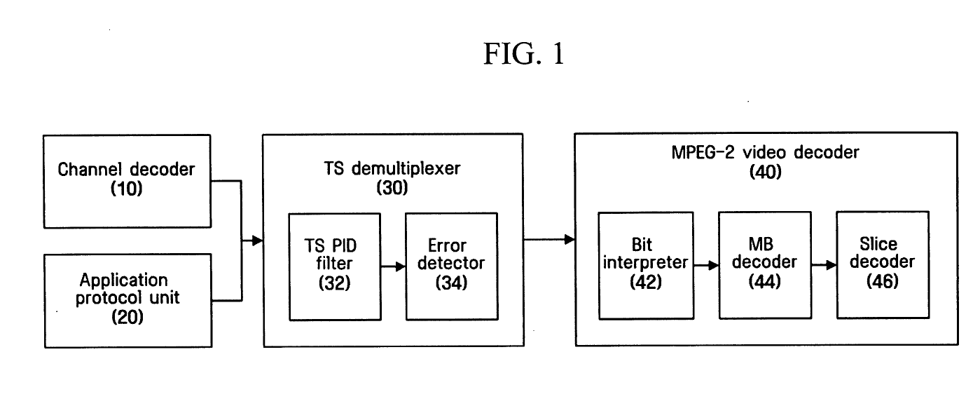

Referring to FIG. 1 showing the configuration of an MPEG-2 video decoding system, a digital TV broadcast signal is received through a channel decoder 10, and packets transmitted through a network such as the Internet is received through an application protocol unit 20. The video decoding system further includes a transport stream (TS) demultiplexer 30 that demultiplexes a broadcast signal (TS packets) received from a broadcasting signal receiver such as the channel decoder 10 or the application protocol unit 20 and extracts a video stream and an MPEG-2 video decoder that decompresses the video stream into a video signal.

The channel decoder 10 receives TS packets by performing RF demodulation on a broadcast signal on a channel selected by a user. Error detection is performed on the received TS packets using channel coding and Cyclic Redundancy Check (CRC). For a packet with an error, a Transport Error Indicator flag in a TS header is set to 1. Furthermore, in the case where a packet is lost during transport, a continuity counter is used to detect the packet loss since continuity counter values for packets preceding and following the lost packet are not continuous.

Meanwhile, a User Datagram Protocol (UDP) is used to transport TS packets over the Internet in real time instead of a Transmission Control Protocol (TCP). When the UDP is used as a transport protocol, a UDP packet typically cannot exceed the maximum packet size of 1,500 bytes in order to maximize transport efficiency. Thus, it is preferable to carry seven 188-byte TS packets in a single UDP packet. In this case, since each TS packet contains a four-bit Continuity Counter field used to check the continuity of up to 16 packets, it is possible to check the continuity of up to 112 (16×7) packets for each UDP packet. When a Real Time Protocol (RTP) that is an application protocol of the UDP is a transport protocol, a 16-bit sequence number field in the RTP packet header is used to check the continuity of 65536 (2¹⁶) TS packets.

A Continuity Counter or a Transport Error Indicator in the header of each TS packet received through the channel decoder 10 or the application protocol unit 20 is used to check a packet loss or damage or the number of lost or damaged packets. Considering that each TS packet contains 188 bytes of data (including 184 bytes of payload), it is also possible to calculate the total amount of information lost.

The TS demultiplexer 30 includes a TS Program Identification (PID) filter 32 and an error detector 34. The TS PID filter 32 filters out only video packets using PID information in a header of each incoming TS packet and creates a bitstream comprised of TS video packets. The error detector 34 adds error information relevant to a packet loss or damage learned through the channel decoder 10 or the application protocol unit 20 when creating a video elementary stream (ES). The error information contains a bitstream indicating the start of an error and the number of damaged or lost TS packets indicating an error size. The error information is preferably recorded in the form of a start code to achieve compatibility with the existing standards. That is, a conventional video decoder skips a portion of a bitstream beginning with an unknown start code while decoding the remaining portion. This will be described later in more detail.

The MPEG-2 video decoder 40 includes a macroblock (MB) decoder 44 and a slice decoder 46. A MB of 16×16 pixels is the basic unit for video compression in the MPEG-2 algorithm.

A bit interpreter 42 delivers bits needed by the MB decoder 44 among a bitstream in a video ES to the slice decoder 46. The lowest level start code in the MPEG-2 bit syntax is a slice start code. When encountering a slice code 0×00 00 01 01 through 0×00 00 01 AF, the slice decoder 46 calls the lower level MB decoder 44 for decoding of slice data from the appropriate slice code before the next start code. The MB decoder 44 detects error information through the bit interpreter 42.

More specifically, the bit interpreter 42 checks and determines the position in a bitstream where an error detected by the TS demultiplexer 30 for indication has occurred through the bitstream in which error information has been indicated during real-time decoding. Thus, it is possible to identify the accurate position within a particular video sequence (picture) where an error has occurred. In other words, MBs from a current MB in which a bitstream with an indication of error information is found to a MB in which the next slice start code is found can be determined to have been corrupted. This is because MBs within a slice contain no position information and are processed sequentially. For example, when each slice consists of 10 MBs, it is impossible to distinguish between corruption of MBs 3 and 7 and that of MBs 3 and 6. Thus, it is determined that all MBs from the first corrupted MB to the last MB in the same slice have been corrupted. Since it is possible to identify the positions of corrupted MBs in a picture, the impact of the corrupted MBs on the displayed picture can be reduced. This will be described later in more detail.

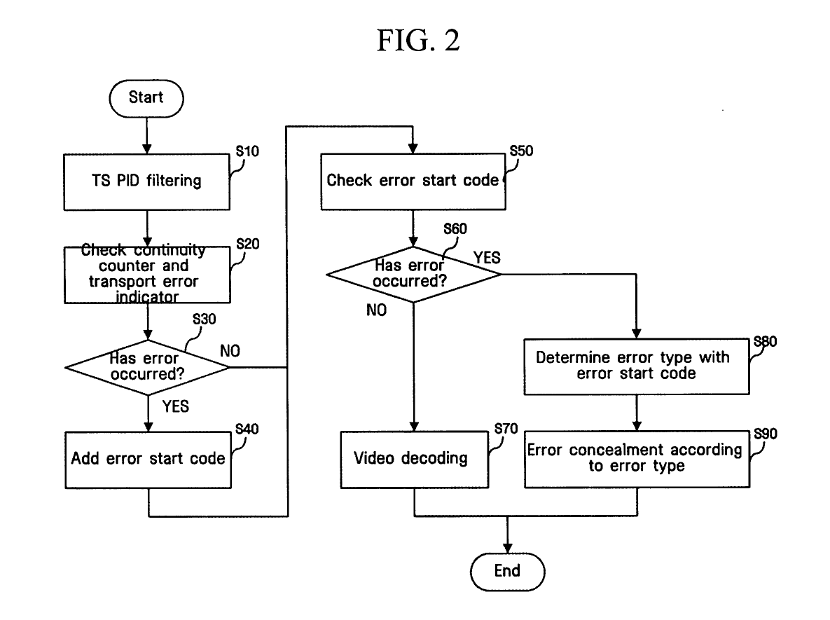

Referring to FIG. 2, which is a flow chart illustrating a video decoding process with error detection according to an exemplary embodiment of the present invention, a TS stream is received for TS PIED filtering in step S10, after which TS packets having video PIDs are collected to create a video TS stream.

In step S20, a Continuity Counter and a Transport Error Indicator of each TS packet within the video TS stream are checked. It is then checked whether an error has occurred in step S30. If the error has occurred, an error start code containing the start position and length of the error is added to the stream, which is then delivered to a video decoder in step S40. Otherwise, the stream is delivered directly to the video decoder.

In step S50, the video decoder checks the error start code during decoding of the received stream. By doing so, it is checked whether an error has occurred in step S60. While a normal video decoding process is performed in step S70 if the error has not occurred, the type of the error is determined using the error start code through a predetermined process in step S80. In step S90, proper error concealment is performed according to the type of the error determined.

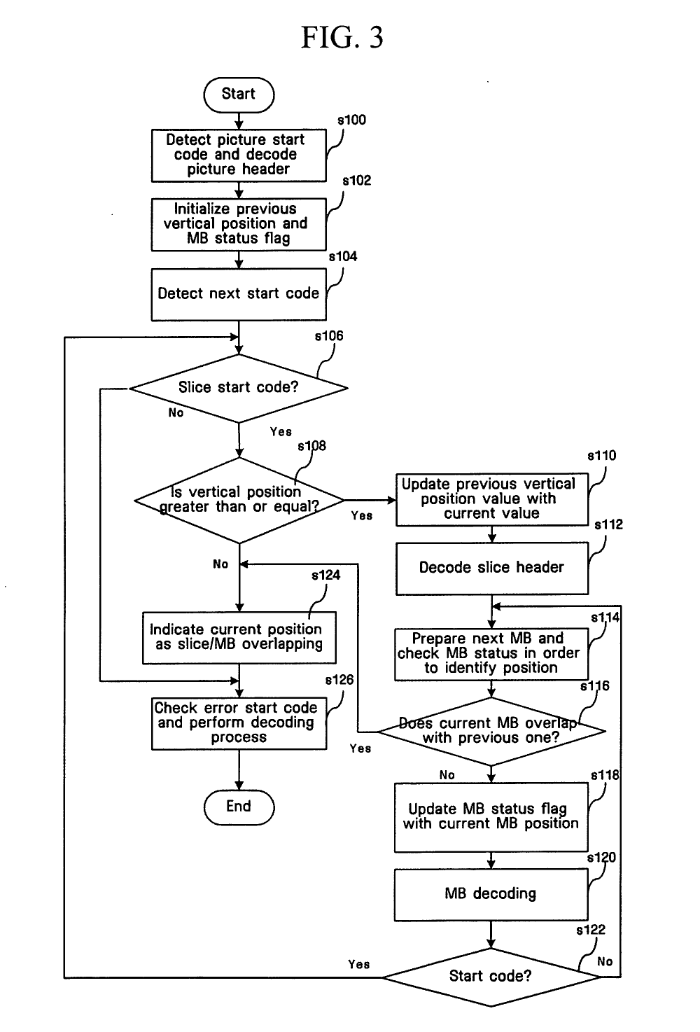

Referring to FIG. 3, which is a flowchart illustrating the detailed process that detects and handles overlapping of a MB/slice, in step S100, a video decoder detects a picture start code and decodes a picture header. In step S102, when a new picture is detected, the vertical position of the previous picture and a status flag for a MB are initialized. Then, the next start code is detected in step S104. In step S106, it is determined whether the detected start code is a slice start code. If it is not a slice start code, since this indicates that an error has occurred, an error start code is checked or a decoding process is performed according to the type of an error in step S126. Conversely, if it is a slice start code, it is determined whether the current vertical position is greater than or equal to the previous vertical position in step S108.

If the current vertical position is less than the previous one, it is determined that the sequence of slices has been changed due to an error between frames. In this case, the current position is indicated as slice/MB overlapping in step S124 and then step S126 is performed. If the current vertical position is greater than or equal to the previous one, the previous vertical position value is updated with the current vertical position value in step S110 and a slice header is decoded in step S112. Then, in step S114, the next MB is prepared and a status of the MB is checked to identify the position. In step S116, it is checked whether the current MB overlaps with the previous one. If both MBs overlap each other, steps S124 and S126 are performed. Otherwise, a MB status flag is updated with the current MB position in step S118 and MB decoding is performed in step S120. Steps S114-S120 are repeatedly performed until a new start code is found. When a new start code is found, the process returns to step S106.

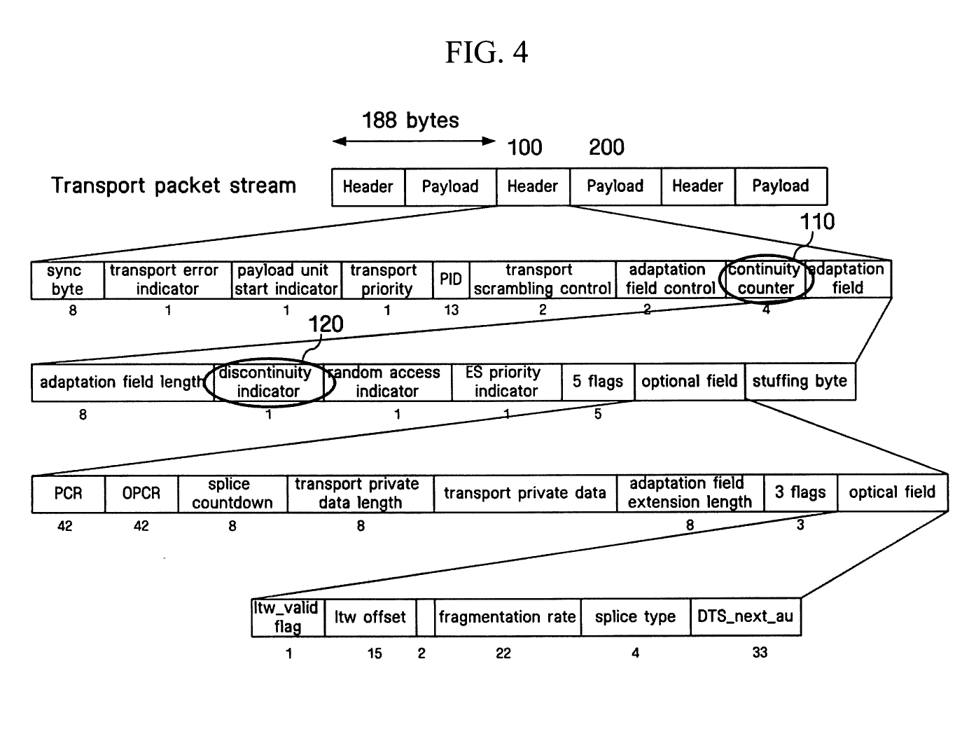

FIG. 4 illustrates the format of a MPEG-2 TS packet. The TS packet has a fixed length of 188 bytes consisting of a 4-byte header 100 and a 184-byte payload 200. The detailed structure of the header 100 is shown in FIG. 4. When a bit of a 1-byte Transport Error Indicator 100 is represented by 1, the TS packet is determined to have been corrupted during transmission. Furthermore, a 4-bit Continuity Counter 120 is used to check whether a loss occurs between successive TS packets. That is, the TS continuity counter increments by one (range 0 to 15) for each successive TS packet. However, the 4-bit field information poses a limitation in determining a loss of up to 15 successive packets.

Meanwhile, when a 2-bit adaptation field control is set to ‘01,’ this indicates each TS packet contains 4 bytes of header and 184 bytes of payload. When the adaptation field control is set to ‘10,’ this indicates that each TS packet contains 4 bytes of header and an adaptation field. When it is set to ‘11,’ each TS packet contains 4 bytes of header, an adaptation field, and a payload. A discontinuity indicator 130 in the adaptation field is set to 1 when successive TS packets have the same or discontinuous continuity counter values. Thus, it is possible to determine if the continuity counter has the same or discontinuous value.

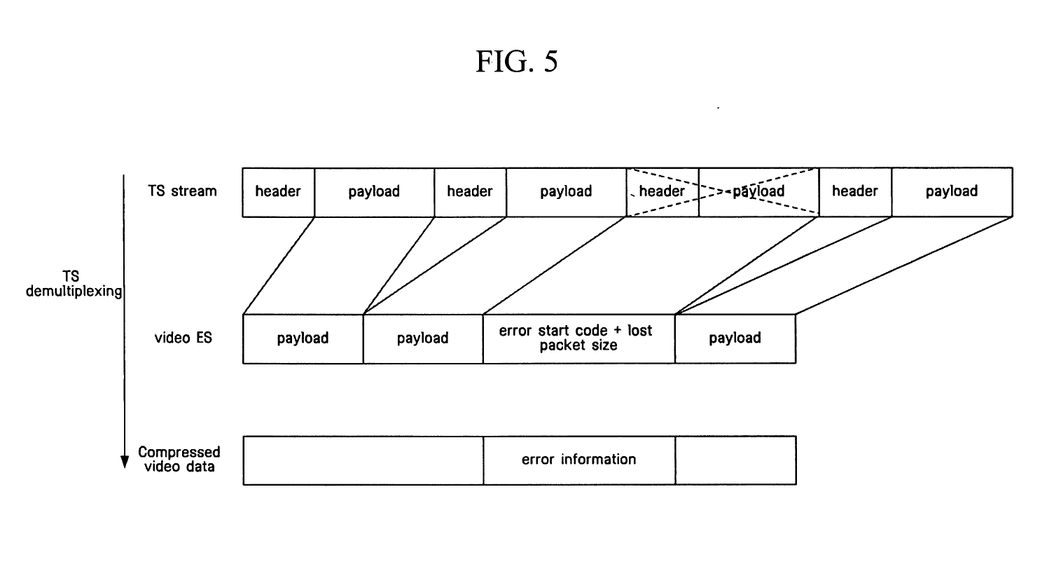

FIG. 5 illustrates an indication of information on an error detected in a stream so that a video decoder can be aware of the error. A TS stream contains video, audio, and other type of data before being subjected to demultiplexing, which are separated by PIDs. Once a video TS stream has been extracted, it is possible to check a loss or damage of TS packets or the number of damaged or lost TS packets using a Continuity Counter or a Transport Error Indicator in the header of each TS packet or information obtained from an appropriate transport protocol. FIG. 5 shows an example of a packet lost during transport, and information on the packet loss is added to a video ES. That is, an error start code is inserted into a portion of a packet determined to have been lost or damaged where a payload will begin, and a size of the damaged or lost packet is recorded in the same portion. A video decoder is able to determine information on the corrupted portion of a video picture and the type of an error using error information detected during decompression (decoding), thereby performing proper error concealment according to the information and the type of error.

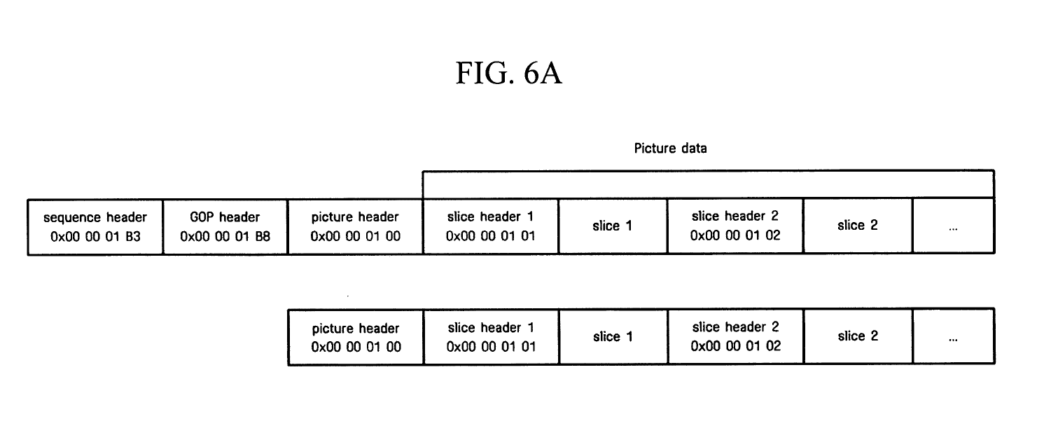

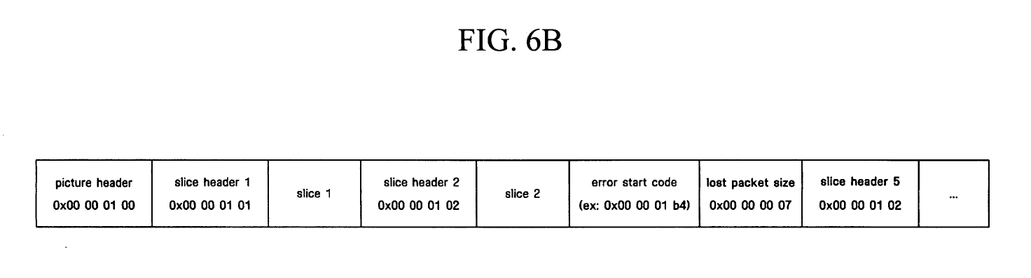

FIG. 6A shows the structure of normal MPEG-2 video data. A video sequence consists of a group of pictures (GOPs), and a picture consists of a series of slices. A slice is composed of a series of MBs which is the basic video encoding/decoding unit. The start of a video sequence is indicated by a sequence start code 0×00 00 01 B3 while the start of a GOP is indicated by a GOP start code 0×00 00 01 B8. A picture begins with a picture start code 0×00 00 01 00 while each slice in a picture begins with a slice start code 0×00 00 01 01 through 0×00 00 01 AF. The sequence of slices can be identified by the last 8 bits in a slice code. For example, 01 represents a slice (at the top of a picture) preceding that indicated by 02. When one picture is finished, a picture start code 0×00 00 01 00 indicating the start of a new picture appears, followed by necessary information such as a variety of parameters and matrices for making up a picture recorded in a picture header.

FIG. 6B shows the structure of MPEG-2 video data in which information on an error has been indicated. As shown in FIG. 6B, slice data 2 is followed by an error start code and slice header 5. That is, an error has occurred from a MB in the slice data 2 or a first MB in slice data 3 to a MB or the last MB in slice data 4. While the error start code is preferably set to 0×00 00 01 B4 indicating an sequence error among start codes defined in the MPEG-2 standard, it may also be set to 0×00 00 01 B0 or 0×00 00 01 B1 reserved for use. By recording a lost packet size after the error start code, it is possible to calculate the position of an error in the picture. The lost packet size may be recorded in bytes, packets, or MBs.

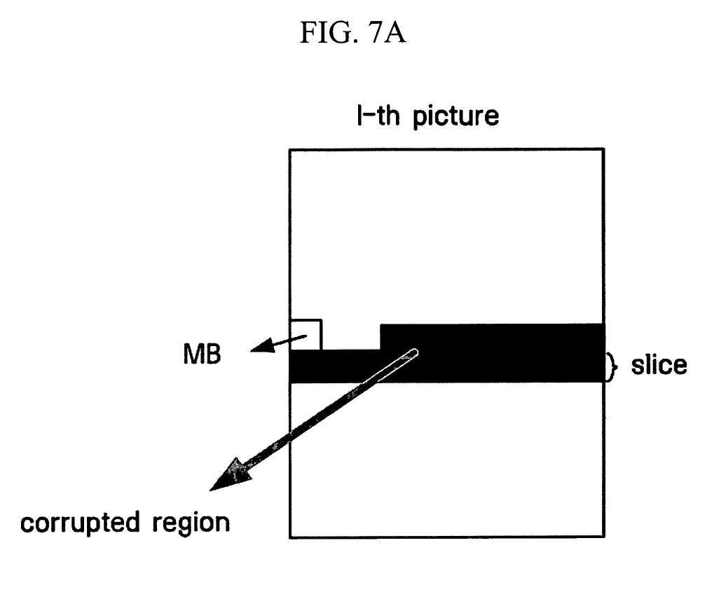

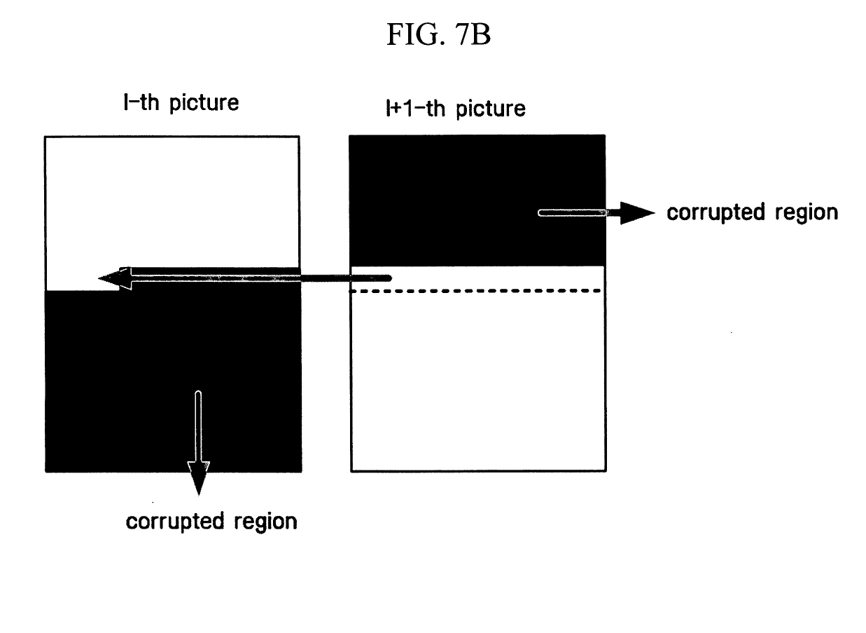

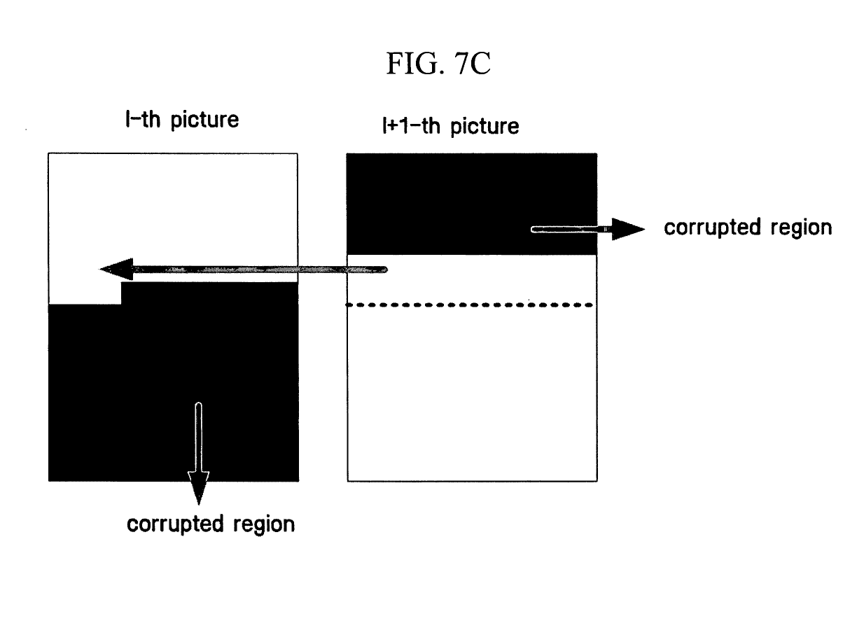

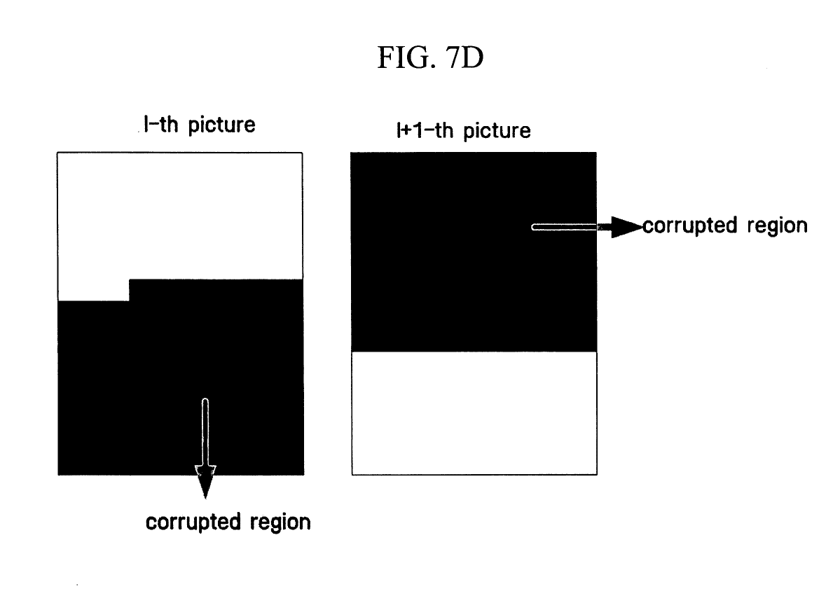

FIGS. 7A-7D show examples of types of possible errors. FIG. 7A is an example in which an error has occurred in a frame (picture), and FIGS. 7B-7D are examples in which errors have occurred between adjacent frames. An interframe error may degrade video quality more seriously than an intraframe error due to corruption of a picture header. When the interframe error occurs, it is not desirable to perform video decoding on a picture with a corrupted picture header.

When an error has occurred within a picture (frame) as shown in FIG. 7A, normal video decoding is performed on a portion of the picture except a corrupted portion where the error has occurred. Proper error concealment is performed on the corrupted portion so that a user is less sensitive to the effect of error. The simplest error concealment approach is to perform video decoding using uncorrupted MBs located at a position in the preceding normal picture (I-1-th picture) corresponding to the position in a picture (I-th picture) where an error has occurred. In this case, the predicted position in a picture where the error has occurred is preferably calculated using motion vectors of the corresponding MBs for video decoding

FIG. 7B shows an example in which an error has occurred due to overlapping of a MB. Since a header in the I+1-th picture is corrupted, the video decoder is not able to discern the difference between the I-th and I+1-th pictures. The position of each slice is identified by a slice start code. Even in the case where one slice overlaps between two pictures, slice overlapping error does not occur since the overlapping slice can be represented by various slice codes. However, performing decoding on MBs in the front and rear pictures causes the number of MBs in one slice to exceed a maximum value. FIG. 7C shows an example of slice overlapping error.

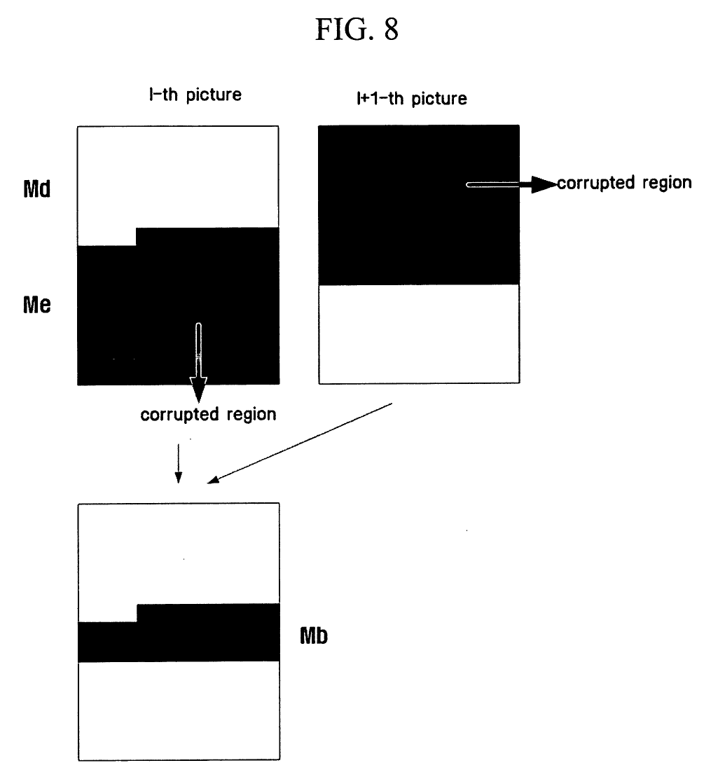

FIG. 7D is an example in which no overlapping of a slice or MB occurs. However, two pictures overlap each other during decoding. In this case, when the two pictures have different header information and the rear picture uses the header information of the front picture, video quality may be seriously hampered. When the error has occurred as shown in FIG. 7D, it may be determined as an interframe error. A method for determining occurrence of an interframe error will now be described with reference to FIG. 8.

FIG. 8 shows an example of a calculation process for determining the type of an error when no slice/MB overlapping error us detected. In this case, it can be determined that an error between frames has occurred using the following calculation method.

Where Pe is the number of lost packets, Pd is the number of packets in a current picture decoded up to the position of an error start code, Md is the number of MBs decoded up to the position of the error start code, and Me is the number of MBs that are estimated to have been corrupted, Me is defined by Equation (1):

$$Me = \frac{Pe}{\frac{Pd}{Md}} \qquad ( 1 )$$

When no slice or MB overlapping occurs, an error between frames is determined to have occurred if Me is greater than or equal to the number of MBs in a picture.

The interframe error means loss of header information in a picture, which results in a serious degradation in video quality, and is determined by the number of corrupted MBs. To handle the interframe error, a predicted picture can be created by using the preceding picture, appropriately changing it, or using motion vector of the preceding picture instead of decoding a picture corrupted due to a loss of the header information. However, by performing video decoding using a slice or MB overlapping error instead of a start code, intraframe errors as shown in FIGS. 7A-7C can be handled properly. Furthermore, by performing decoding in units of two or more pictures, it is possible to determine a position of a frame where an error has occurred even when occurring interframe, as shown in FIG. 7D.

While the present invention has been particularly shown and described with reference to exemplary embodiments using MPEG-2 TS, it will be understood by those of ordinary skill in the art that various changes in form and details may be made therein without departing from the spirit and scope of the present invention as defined by the following claims. That is, the present invention can be applied to other video coding algorithms compliant with MPEG-1, MPEG-4, and MPEG-7 standards or H.264-compliant video coding techniques.

The present invention makes it possible to determine errors in a frame or between frames during video decoding as well as the position of the errors. Thus, a video decoder is capable of improving video quality by performing proper error concealment according to the type of an error.

1. A video decoding method with error detection, the method comprising:
detecting an error in a received video stream having a predetermined format;
recording error information at a predetermined location of the video stream; and
determining a type of the error using the error information recorded in the video stream and decoding the video stream according to the result of determination.

2. The method of claim 1, wherein the format of the video stream is compliant with Moving Pictures Experts Group (MPEG) standards.

3. The method of claim 2, wherein in the recording of the error information, information containing a start position and a length of the error is recorded in the video stream using information about lost or damaged Transport Stream (TS) packets detected during channel decoding for digital TV broadcasting.

4. The method of claim 2, wherein in the detecting of the error and recording of the error information, packets lost during transmission over the Internet are detected using at least one of header information of a transport protocol, header information of packets being transmitted, and information containing a start position, and a length of the error in the video stream is recorded in the video stream.

5. The method of claim 3, wherein the information containing the start position and length of the error in the video stream is recorded in the form of a start code.

6. The method of claim 4, wherein the information containing the start position and length of the error in the video stream is recorded in the form of a start code.

7. The method of claim 1, wherein the type of the error is classified into an error within a frame and an error between frames for determination, and video decoding is performed according to the type of the error determined.

8. The method of claim 2, wherein the type of the error is classified into an error within a frame and an error between frames for determination, and video decoding is performed according to the type of the error determined.

9. The method of claim 7, wherein when the determined error is an error within a frame, decoding is performed on the frame with the error using blocks in a temporally preceding frame corresponding to a position in the frame where the error has occurred.

10. The method of claim 8, wherein when the determined error is an error within a frame, decoding is performed on the frame with the error using blocks in a temporally preceding frame corresponding to a position in the frame where the error has occurred.

11. The method of claim 7, wherein when the determined error is an error between frames, video decoding is performed on a temporally preceding frame instead of a frame with a lost or damaged region placed at the beginning part of the frame.

12. The method of claim 8, wherein when the determined error is an error between frames, video decoding is performed on a temporally preceding frame instead of a frame with a lost or damaged region placed at the beginning part of the frame.

13. A video decoder with error detection, comprising:
a broadcast signal receiver that extracts a broadcast stream of a predetermined format from a broadcast signal being transmitted via a transmission medium;
a demultiplexing and error detection unit that demultiplexes the broadcast stream extracted by the broadcast signal receiver to extract a video stream, detects errors in packets making up the extracted video stream, and records error information at a predetermined location of the video stream; and
a video decoding unit that interprets the error information, determines a type of the errors using a predetermined method, and decodes the video stream according to the result of determination.

14. The video decoder of claim 13, wherein the format of the video stream extracted by the broadcast signal receiver is compliant with Moving Pictures Experts Group (MPEG) standards.

15. The video decoder of claim 14, wherein the broadcast signal receiver displays, on the header of the packet, the information about a packet lost or damaged while extracting a broadcast stream from a broadcast signal transmitted for digital TV broadcasting, and the demultiplexing and error detection unit demultiplexes the broadcast stream for extraction of the video stream and records error information containing a start position and a length of the error in the video stream using the information about the lost or damaged packet displayed on the header.

16. The video decoder of claim 14, wherein the broadcast signal receiver extracts a broadcast stream using header information of packets transmitted over the Internet, and the demultiplexing and error detection unit demultiplexes the broadcast stream to extract a video stream and records error information containing a start position and a length of the error in the video stream using at least one of header information of a transport protocol and the header information of packets transmitted over the Internet.

17. The video decoder of claim 15, wherein the demultiplexing and error detection unit records information containing the start position and length of the error in the video stream in the form of a start code.

18. The video decoder of claim 16, wherein the demultiplexing and error detection unit records information containing the start position and length of the error in the video stream in the form of a start code.

19. The video decoder of claim 14, wherein the video decoding unit classifies the type of the errors as an error within a frame and an error between frames for determination and performs video decoding according to the type of the error determined.

20. The video decoder of claim 15, wherein the video decoding unit classifies the type of the errors as an error within a frame and an error between frames for determination and performs video decoding according to the type of the error determined.

21. The video decoder of claim 19, wherein when the determined error is an error within a frame, the video decoding unit decodes the frame with the error using blocks in a temporally preceding frame corresponding to a position in the frame where the error has occurred.

22. The video decoder of claim 20, wherein when the determined error is an error within a frame, the video decoding unit decodes the frame with the error using blocks in a temporally preceding frame corresponding to a position in the frame where the error has occurred.

23. The video decoder of claim 19, wherein when the determined error is an error between frames, the video decoding unit decodes a temporally preceding frame instead of a frame with a lost or damaged region placed at the beginning part of the frame.

24. The video decoder of claim 20, wherein when the determined error is an error between frames, the video decoding unit decodes a temporally preceding frame instead of a frame with a lost or damaged region placed at the beginning part of the frame.
